(19) United States
(12) Patent Application Publication
(10) Pub. No.: US 2005/0175343 A1
(43) Pub. Date: Aug. 11, 2005

(54) System and apparatus for a carrier class WDM PON for increased split number and bandwidth

(75) Inventors: William X. Huang, San Ramon, CA (US); Jer-Chen Kuo, Davis, CA (US); Ten-Ling Ti, San Jose, CA (US); Liming Gao, Alameda, CA (US); Weizhong Tang, Castro Valley, CA (US)

Correspondence Address: FELIX L. FISCHER, ATTORNEY AT LAW, 1607 MISSION DRIVE, SUITE 204, SOLVANG, CA, 93463, US

(73) Assignee: UTStarcom, Inc.

(21) Appl. No.: 11/044,426

(22) Filed: Jan. 26, 2005

Related U.S. Application Data
(60) Provisional application No. 60/541,783, filed on Feb. 3, 2004.

(51) Int. Cl. H04J 14/00

(52) U.S. Cl. 398/66

(57) ABSTRACT

A Passive Optical Network (PON) is provided with enhance split capability and bandwidth by employing Wavelength Division Multiplexer (WDM) elements in combination with optical couplers at optical distribution nodes (ODN) intermediate a local exchange office node and a customer node. The local exchange office node transmitting and receiving signals from a single optical fiber through a WDM and each customer node connected to one leg of an optical coupler in the ODN with a WDM for received and transmitted signals. Upstream transmission is accomplished with a single wavelength.

### CROSS-REFERENCE TO RELATED APPLICATIONS

This application claims priority of Provisional Applications having Ser. No. 60/541,783 filed on Feb. 3, 2004 entitled System and Apparatus for a Carrier Class WDM PON for Increased Split Number and Bandwidth.

### BACKGROUND OF THE INVENTION

1. Field of the Invention

This invention relates generally to the field of telecommunications network transmission systems and, more particularly, to a wavelength division multiplexing Passive Optical Network (PON) that provides an increased number of splits and bandwidth through the combination of Wavelength Division Multiplexer (WDM) and optical coupler elements.

2. Description of the Related Art

Existing Passive Optical Networks are commonly found in use for broadband fiber optic access network. The PON uses a means of sharing fiber to the home without running individual fiber optic lines from an exchange point, telephone company Local Exchange Office (LEO) or a CATV Headend to the subscriber's home.

The main challenge of existing Passive Optical Network is to increase the number of subscribers sharing with one fiber whether in a bus or loop configuration. The higher split causes the optical power to be reduced in the far end receiver. Typically, for the objectives defined, the ITU-G.983 Passive Optical Network standard allows 32 splits and IEEE802.3ah Point To Multiple Point standard allows for 16 splits.

Another problem associated with increasing the number of users sharing a fiber is that average bandwidth to each user also decreased. A typical PON has bandwidth sharing among all the subscriber users. For example, one Gigabit of downstream bandwidth shared by 16 users provides about 60 Mb/s, where a 32 split results in 30 Mb/s for each user, a 64 split results in 15 Mb/s, and a 128 split results in 7 Mb/s.

It is therefore desirable to provide a PON that has higher split ratio and bandwidth.

### SUMMARY OF THE INVENTION

The present invention is a Passive Optical Network (PON) employing a local exchange office node having a first WDM with M channels for downstream signal transmission and a second WDM interconnecting the first WDM to an optical fiber. The second WDM receives the M downstream transmission channels from the first WDM and a single upstream transmission channel from the optical fiber. An optical distribution node is connected to the optical fiber through a third WDM for communication with the second WDM and incorporates a fourth WDM connected to the third WDM for receiving the M downstream transmission channels. A 1×M optical coupler is connected to the third WDM for transmission of the upstream channel and M 2×N optical couplers are each connected to the forth WDM and the 1×M optical coupler. M×N customer nodes are provided with each having a fifth WDM to receive downstream transmission signals and transmit upstream transmission signals to the respective 2×N coupler.

### BRIEF DESCRIPTION OF THE DRAWINGS

These and other features and advantages of the present invention will be better understood by reference to the following detailed description when considered in connection with the accompanying drawings wherein:

FIGS. 1a-e are block diagrams showing the various PON configurations in which the present invention can be employed;

FIG. 2 is a block diagram demonstrating the elements of a system embodying the present invention; and,

FIG. 3 is a block diagram of an exemplary distribution node in a system incorporating the invention.

### DETAILED DESCRIPTION OF THE INVENTION

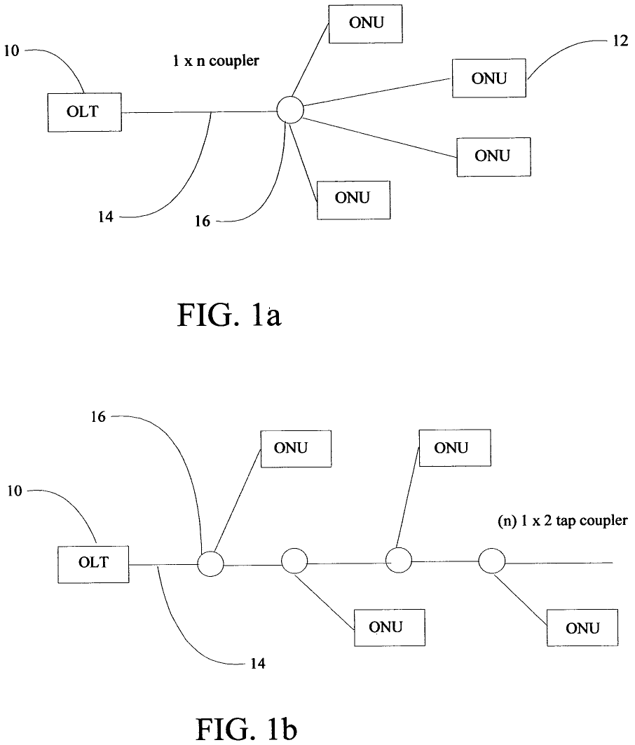

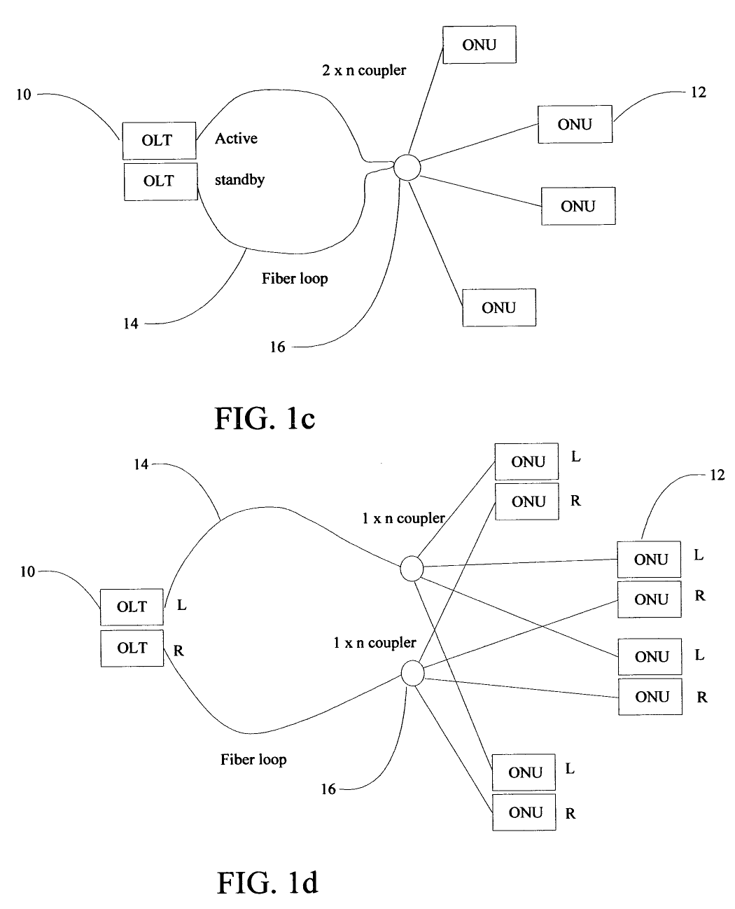

Referring to FIGS. 1a-e, a passive optical network (PON) is a system that brings Optical Fiber cabling and signals all or most of the way to the end user. Depending on where the PON terminates, the system can be described as fiber-to-the-curb (FTTC), fiber-to-the-building (FTTB), or fiber-to-the-home (FTTH). A PON consists of an Optical Line Termination (OLT) 10 at the communication company's office and a number of Optical Network Units (ONUs) 12 near end users. Typically, up to 32 ONUs can be connected to an OLT. The term “passive” simply describes the fact that optical transmission has no power requirements or active electronic parts once the signal is going through the network. The main components in PON are Optical Fiber 14 and Couplers 16. Each coupler combines or splits power from optical fibers. It is used in the PON to distribute optical signal to and from multiple subscriber lines.

FIG. 1a discloses a PON with a basic tree structure wherein the ONUs are connected to the OLT through one 1×n coupler from a single optical fiber to a branch optical fiber for each ONU. FIG. 1b discloses a bus structure in which each ONU has a separate coupler (n 1×2 couplers) on a single optical fiber “bus”.

FIG. 1c discloses a PON with a trunk protected tree wherein two OLTs are present on a fiber optic loop with one OLT active and one standby. The coupler is a 2×n to accommodate the two “halves” of the loop connecting with the OLTs. FIG. 1d discloses a fully redundant tree with two OLTs, as in the trunk protected tree, with a 1×n coupler at the termination point of the fiber optic loop and each user location has two ONUs, one communicating through each of the couplers to the respective live or redundant OLT.

FIG. 1e shows a fully redundant bus architecture with two OLTs and two ONUs at each user location connected to the fiber loop bus through a 2×2 coupler.

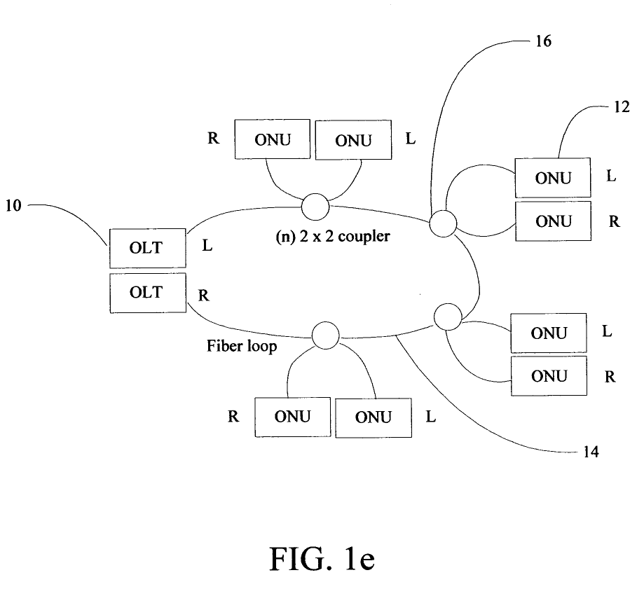

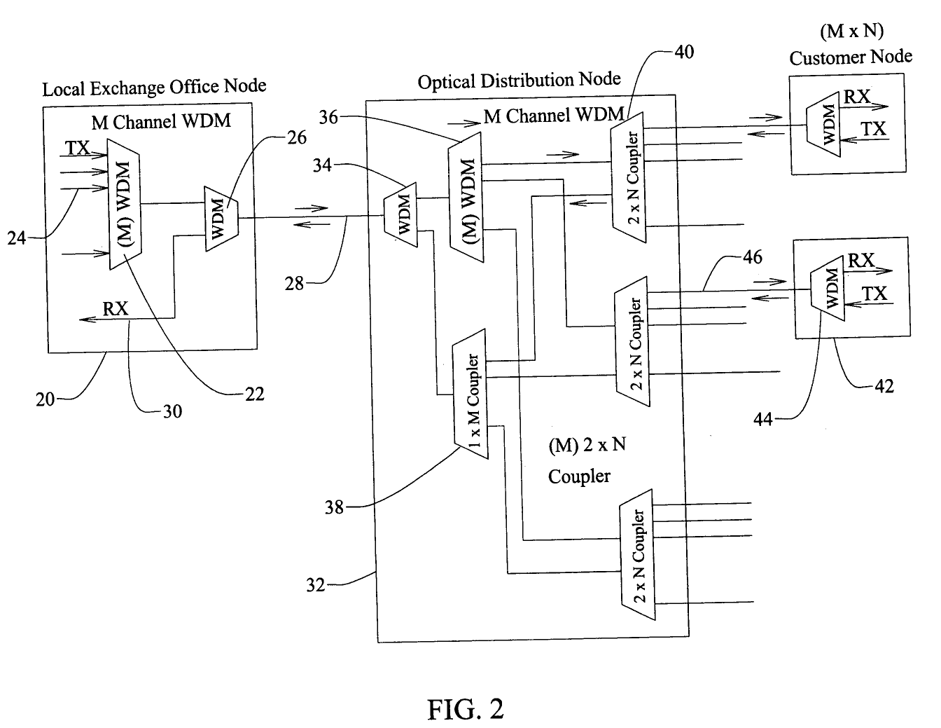

Wavelength Division Multiplexers (WDM) allow several signals to be sent through one optical fiber with different wavelengths of light to avoid interference in the signals. Referring to FIG. 2, in a local exchange office node 20, which can constitute the OLT for the PON as described above in the present invention, employs a WDM 22 having M channels for multiplexing M wavelengths for M channels 24 of transmission in the downstream direction. A second WDM 26 provides bidirectional transmission on an optical fiber 28 of the M downstream channels plus one upstream channel. The upstream transmissions received by the CON are accomplished on a single wavelength or channel 30. As an example, eight channels consisting of 1470/1490/1510/1530/1550/1570/1590/1610 nm are employed in the downstream transmission system. A single wavelength of 1310 nm is employed for the upstream direction. An exemplary WDM employed in intended embodiments of the invention as described for the CON, ODN and Customer Nodes described below is manufactured by Optowaves, Inc. 780 Montague Expressway, Suite 403, San Jose, Calif. 95131 with part number CWDM-8-1470-1-SC/UPC. It should be understood that the unidirectional WDMs described herein may be replaced in alternative embodiments with combined bidirectional WDMs providing both downstream and upstream transmission capability.

An Optical Distribution Node (ODN) 32 replaces the conventional coupler of the PON. The ODN incorporates a WDM 34 which communicates with the optical fiber 28 and provides M channels of downstream transmission to a second WDM 36 having M channels. A 1×M coupler 38 communicates with WDM 34 for the upstream transmission signals. M units of 2×N couplers 40 are connected to the M channel WDM 36 to receive and distribute the downstream transmissions and to provide the single channel of upstream transmissions by connection to the M+1 channel WDM 34 thereby providing the capability for M×N downstream connections. An exemplary WDM employed for this purpose in intended embodiments of the invention is produced by Optowaves, Inc. 780 Montague Expressway, Suite 403, San Jose, Calif. 95131 under part number P/N: STC-2×16-135-P-09-1-SC/UPC.

Customer nodes 42, which constitute the ONU of the PON, each incorporate a WDM 44 which transmits both upstream and downstream transmission signals through optical fibers 46 connected from each WDM 44 to the respective 2×N coupler 40 at the ODN.

In an embodiment using the exemplary 8 channels in the M channel WDMs and a 16 split optical coupler for the 2×N coupler (N=16), 128 customer nodes can be supported on a single optical fiber 28 from the local exchange office node or OLT. Using a 36 core fiber cable and employing the configuration of local exchange office nodes, ODNs and customer nodes of the present invention allows a total of 4,608 OLTs to be supported. Bandwidth sharing in the downstream direction is the Data Rate/(M×N). Only one wavelength is used in the upstream direction, however most home use subscribers, as an example, do not require high bandwidth in the upstream direction.

A typical optical receiver has wide wavelength response range. Each customer node receiver is able to receive the wavelengths of all M channels. A single wavelength in the upstream direction allows use of a single laser type and provides significantly lower inventorying costs by allowing a single type of customer node box.

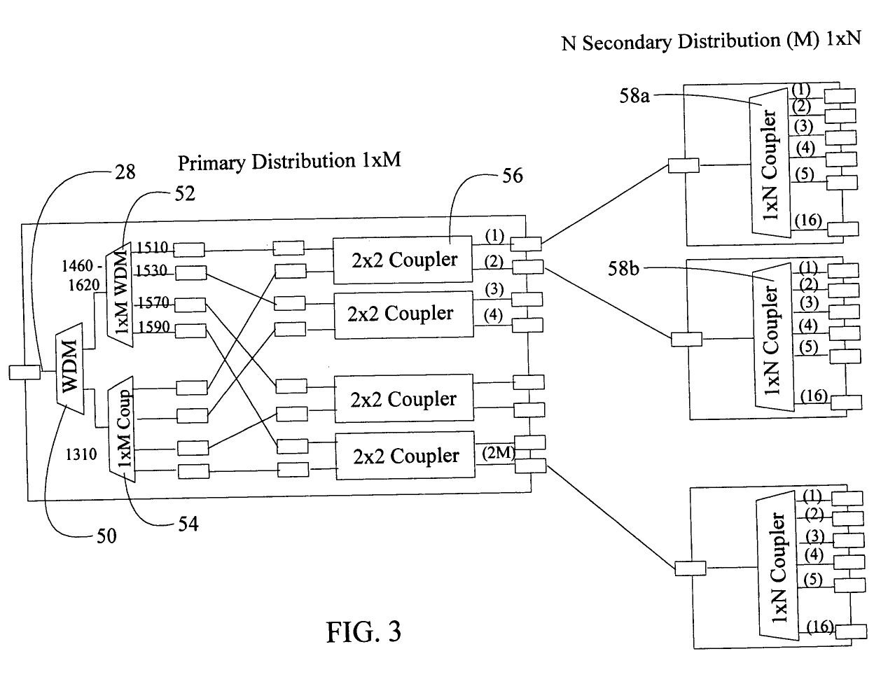

An alternative exemplary ODN is shown in FIG. 3. The incoming fiber 28 is received in WDM 50 which splits the M downstream transmission channels and the upstream channel, providing the downstream channels to a 1ΔM WDM 52 and receiving the upstream channel from 1×N coupler 54. In the exemplary embodiment shown, the downstream channels span 1460 to 1620 nm and four specific channels, 1510, 1530, 1570 and 1590 are shown emanating from the WDM 52. Multiple 2×2 couplers 56 each receive one of the M downstream channels from WDM 52 and a split of the upstream channel through connection with 1×M coupler 54. In the example shown, the first 2×2 coupler carries a 1510 nm downstream wavelength and the 1310 nm upstream wavelength.

The 2×2 couplers are each connected to two 1×N couplers 58a and 58b. For the example shown, N is 16 and coupler 58a provides 16 connections for the downstream wavelength of 1510 nm. Complimentary coupler 58b provides 16 connections for the upstream wavelength 1310 nm. A fiber pair, one each from couplers 58a and 58b is then provided to each customer node.

Having now described the invention in detail as required by the patent statutes, those skilled in the art will recognize modifications and substitutions to the specific embodiments disclosed herein. Such modifications are within the scope and intent of the present invention as defined in the following claims.

1. A Passive Optical Network (PON) employing a single optical fiber for connection from a local exchange office node to a plurality of customer nodes comprising:
a Local Exchange Office first Wavelength Division Multiplexer (WDM) system with M wavelength channels for downstream signal transmission connected to an optical fiber transmission system;
a plurality of optical distribution nodes connected to the optical fiber transmission system for communication with the first WDM system and including a first optical coupler connected for communication with a second plurality of customer nodes, each customer node communicating through a WDM using selected wavelengths from the first WDM system.

2. A PON as defined in claim 1 wherein the first WDM system comprises:
a first Wavelength Division Multiplexer (WDM) with M channels for downstream signal transmission; and,
a second WDM interconnecting the first WDM to an optical fiber, the second WDM receiving the M downstream transmission channels from the first WDM and a single upstream transmission channel from the optical fiber.

3. A PON as defined in claim 2 wherein the first optical coupler comprises:
a 1×M optical coupler for transmission of the upstream channel, and
M 2×N optical couplers each connected for transmission of the M downstream channels and to the 1×M optical coupler;
and the WDM in each customer node is connected to a leg of a respective one of the 2×N couplers to receive downstream transmission signals and transmit upstream transmission signals.

4. A PON as defined in claim 3 wherein the optical distribution nodes further comprise:
a third WDM connected to the optical fiber for communication with the second WDM and connected with the 1×M optical coupler to receive the upstream channel; and,
a fourth WDM connected to the third WDM and receiving therefrom the M downstream transmission channels and connected to the M 2×N optical couplers.

5. A Passive Optical Network (PON) employing a single optical fiber for connection from a local exchange office node to a plurality of customer nodes comprising:
a first Wavelength Division Multiplexer (WDM) with M channels for downstream signal transmission;
a second WDM interconnecting the first WDM to an optical fiber, the second WDM receiving the M downstream transmission channels from the first WDM and a single upstream transmission channel from the optical fiber;
an optical distribution node connected to the optical fiber and having a third WDM receiving the M downstream transmission channels from the first WDM and a single upstream transmission channel from the optical fiber;
a 1×M WDM receiving the M downstream transmission channels from the third WDM;
a 1×M coupler connected to the third WDM for transmission of the upstream wavelength;
a plurality of M 2×2 couplers each connected to the 2×M WDM and the 1×M coupler for receiving one of the downstream wavelengths and the upstream wavelength; and,
a plurality of 2M 1×N couplers connected in pairs to the M 2×2 couplers for connection to customer nodes for distribution of the respective downstream wavelengths and upstream wavelength.

6. A Passive Optical Network (PON) employing a single optical fiber for connection from a local exchange office node to a plurality of customer nodes comprising:
a local exchange office node having
Wavelength Division Multiplexing means having M channels for downstream signal transmission and one channel for upstream transmission and connected to an optical fiber;
an optical distribution node having
a second Wavelength Division Multiplexing means connected to the optical fiber for communication with the first Wavelength Division Multiplexing means and receiving therefrom the M downstream transmission channels and providing thereto the upstream channel,
a 1×M optical coupler connected to the second Wavelength Division Multiplexing means for transmission of the upstream channel, and
M 2×N optical couplers each connected to the second Wavelength Division Multiplexing means and the 1×M optical coupler; and,
M×N customer nodes, each having a third Wavelength Division Multiplexing means connected to a leg of a respective one of the 2×N couplers to receive downstream transmission signals and transmit upstream transmission signals.

7. A Passive Optical Network (PON) as defined in claim 6 wherein
the Wavelength Division Multiplexing means comprises
a first Wavelength Division Multiplexer (WDM) with M channels for downstream signal transmission and
a second WDM interconnecting the first WDM to an optical fiber, the second WDM receiving the M downstream transmission channels from the first WDM and a single upstream transmission channel from the optical fiber;
the second Wavelength Division Multiplexing means comprises
a third WDM connected to the optical fiber for communication with the second WDM,
a fourth WDM connected to the third WDM and receiving therefrom the M downstream transmission channels, and
the 1×M optical coupler is connected to the third WDM for transmission of the upstream channel,
the M 2×N optical couplers are each connected to the forth WDM and the 1×M optical coupler; and,
the third Wavelength Division Multiplexing means in the M×N customer nodes, each comprises a fifth WDM connected to a leg of a respective one of the 2×N couplers to receive downstream transmission signals and transmit upstream transmission signals.
